(19) United States
(12) Patent Application Publication
(10) Pub. No.: US 2018/0063249 A1
(43) Pub. Date: Mar. 1, 2018

(54) SYSTEM AND METHOD FOR CONTROLLING SMART DEVICES

(71) Applicant: VU TRONG NGUYEN, SAN JOSE, CA (US)

(72) Inventor: VU TRONG NGUYEN, SAN JOSE, CA (US)

(21) Appl. No.: 15/243,969

(22) Filed: Aug. 23, 2016

(51) Int. Cl. H04L 29/08; H04W 4/06; H04W 4/00; H04L 29/06; G10L 15/22; G10L 15/30

(52) U.S. Cl. CPC H04L 67/125; H04W 4/06; H04W 4/008; H04W 88/02; G10L 15/22; G10L 15/30; H04L 67/42

(57) ABSTRACT

A system and method for controlling smart devices is disclosed which includes a voice activation device operable to receive, recognize, and transform human voices into electrical signals; a smart gateway, mounted directly below the voice activation device into a single removable unit so as to reduce interferences and to maintain Bluetooth connections with the voice activation device, operable to transform the electrical signals into text commands that control the operations of smart devices.

### FIELD OF THE INVENTION

The present invention relates generally to the field of smart devices. More specifically, the present invention relates to voiced control device, personal assistance, and user interface for smart devices.

### BACKGROUND ART

Voice recognition device such as the Amazon Echo® can be integrated with a variety of home automation hubs to control the operations of smart devices such light switches, light bulbs, dimmable lights, door locks, garage door openers, thermostats, closures, etc., by using human voice commands. For example, a user may turn on the bedroom lights by speaking aloud, “Alexa, turn on the living room lights”, or “Alexa, open the front door lock” to open the front door for a guest.

The operation of the above Amazon Echo® and home automation hub can be summarized as follows: when a user speaks aloud, the microphones of the Amazon Echo® receive the voice command and send it to Amazon cloud AWS (Amazon Web Service) via WAN (Wide Area Network). The AWS of Amazon, in turn, translates the voice command into a text command. This text command is then sent back to the home automation hub from the AWS cloud. Finally, the home automation hub sends that text command wirelessly to one of its connected smart devices to perform the original voice command.

Currently in the market, the home automation hubs are positioned separately at a location far away from the Amazon Echo®. Such a setup incurs the following problems: first, such a setup is inconvenient for the users because there are too many components at different locations; second, Bluetooth signals from the home automation hub can be interfered by other Bluetooth signals from other Bluetooth devices and/or other 2.4 GHz wireless signals nearby; and third, if the home automation hubs are located too far from Amazon Echo®, due to the piecemeal setup and other obstacles of the rooms, they cannot communicate to each other because the range of Bluetooth signals is very limited.

Furthermore, in the current setups, Amazon Echo® voice cannot report the status of each home automation command back to the user thru its speakers. Conventionally, the Amazon Echo® voice only announces “Okay” when a command is executed. On the other hand, when the smart device malfunctions, the Amazon Echo® voice only announces that, “the device ABC is not responding”. Therefore, the user does not know any other important details whether a smart home device fails to be added into or removed from the database, and/or whether the requested command has been executed successfully. This is where the speakers of the automation hub become important because the affirmation of whether a device is successfully added in or removed from the database improves the reliability and user confidence in the operation. This increases the overall usability of the entire system.

Therefore what is needed is a system that can overcome the above described problems.

### SUMMARY OF THE INVENTION

Accordingly, an objective of the present invention is to provide a combined smart gateway mounted directly below a voice recognition system which provides solutions to the problems described above. Thus, a system and method for controlling smart devices are disclosed to include a voice activation device operable to receive, recognize, and transform human voices into electrical signals; a smart gateway, mounted directly below the voice activation device into a single removable unit so as to reduce interferences and to maintain Bluetooth connections with the voice activation device, operable to transform the electrical signals into text commands that control the operations of smart devices.

Another objective of the present invention is to provide a method for controlling smart devices including the steps of providing a voice activation device, designing a smart gateway so that the voice activation device is adapted to mount directly on top of the smart gateway into a single removable unit, mechanically and electrically connecting the voice activation device directly on top of the smart gateway into the single removable unit, and operating the single removable unit to control smart devices using human voice commands and reporting the status of each command.

These and other advantages of the present invention will no doubt become obvious to those of ordinary skill in the art after having read the following detailed description of the preferred embodiments, which are illustrated in the various drawing Figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1A is a mechanical drawing of a system for controlling smart devices which includes a voice recognition device such as an Amazon Echo® and a smart gateway in accordance with an embodiment of the present invention

FIG. 1B is a mechanical drawing of a system for controlling smart devices which includes a voice recognition device such as an Amazon Echo® mounted directly on top of the smart gateway into a single removable unit in accordance with an embodiment of the present invention;

FIG. 2A is a mechanical drawing illustrating the components of the smart gateway in accordance with an embodiment of the present invention;

FIG. 2B is a mechanical drawing showing the front side of the smart gateway and a wall-mount AC adaptor power unit in accordance with an embodiment of the present invention;

FIG. 2C a mechanical drawing illustrating the other side of the smart gateway and the wall-mount AC adaptor power unit in accordance with an embodiment of the present invention

FIG. 3 is a schematic diagram illustrating the main electrical components of the smart gateway in accordance with an embodiment of the present invention;

FIG. 4 is a diagram illustrating the wireless connections between the smart gateway and a voice recognition device such as an Amazon Echo® to control smart devices in accordance with an embodiment of the present invention; and

FIG. 5 is a flowchart illustrating a method for controlling smart devices in accordance with an embodiment of the present invention.

### DETAILED DESCRIPTION OF THE INVENTION

Reference will now be made in details to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in details so as not to unnecessarily obscure aspects of the present invention.

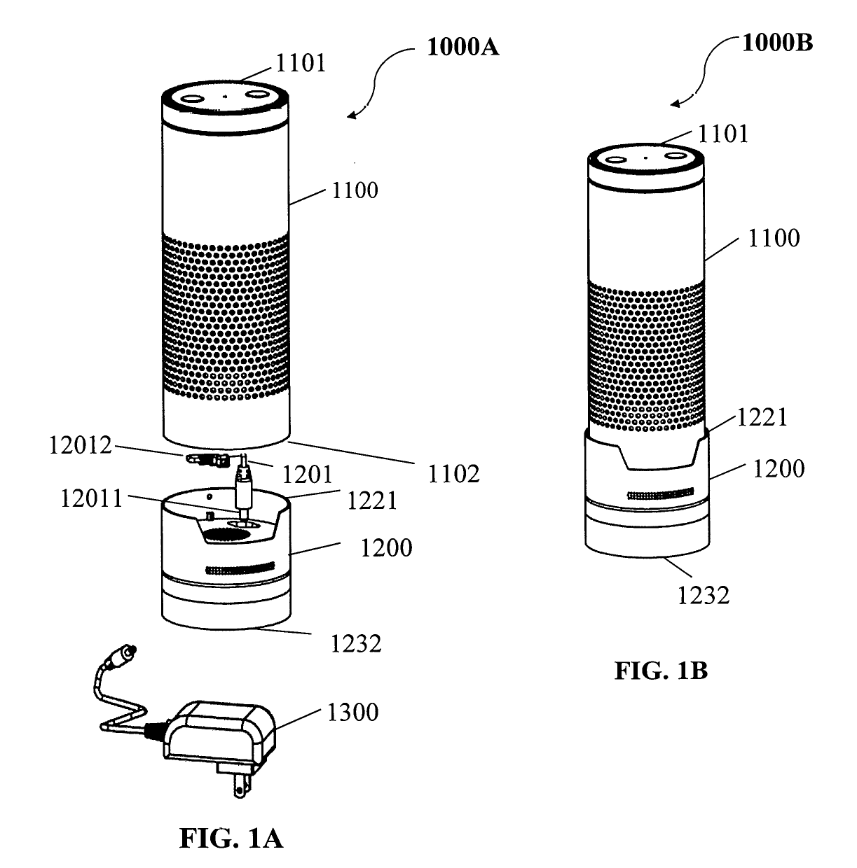

Exemplary embodiments of the present invention are now described with reference to FIGS. 1 to 5. FIG. 1A is a mechanical drawing of a system for controlling smart devices 1000A (hereinafter referred to as “system 1000A”) when it is not connected as a single removable unit in accordance with an exemplary embodiment of the present invention. System 1000A includes a voice recognition device 1100, a smart gateway 1200, a DC power adaptor cable 1201, and a wall-mount AC adapter power unit 1300. Voice recognition device 1100 has a top side 1101 and a bottom side 1102. Smart gateway 1200 also has a top side 1221 and a bottom side 1232. In a preferred embodiment, smart gateway 1200 of the present invention is mechanically designed such that bottom side 1102 of voice recognition device 1100 is mechanically mounted directly to top side 1221 of smart gateway 1200. One end of DC power adapter cable 1201 is a female 2.1 mm connector 12011 while the other end is a female 1.35 mm connector 12012. DC power adapter cable 1201 is adapted to connect to a male 2.1 mm DC jack 12011 of smart gateway 1200 which protrudes upward. 2.1 mm DC jack 12012 is, in turn, connected to the male 1.35 mm DC jack (not shown) of voice recognition device 1100 at bottom side 1102. Wall-mount AC adapter power unit 1300 is a wall mount plug-in.

Referring next to FIG. 1B, a mechanical drawing of voice recognition device 1100 mounted directly on top of smart gateway 1200 into a single removable unit 1000B (“system 1000B”) is illustrated in accordance with an embodiment of the present invention. In FIG. 1B, voice recognition device 1100 is mechanically mounted directly on top of smart gateway 1200. Specifically, DC power adaptor cable 1201 is used to connect male 2.1 mm DC jack 12011 of smart gateway 1200 to the male 1.35 mm DC jack (not shown) of voice recognition device 1100 at bottom side 1102, then bottom side 1102 of voice recognition device 1100 is slid into the opening of top side 1221 of smart gateway 1200. When voice recognition device 1100 is mechanically mounted directly on top of smart gateway 1200 into a single removable unit 1000B as shown above, system 1000B achieves the following advantages. The first advantage is that system 1000B is built into a single unit without too many components scattered around the house. The second advantage is both voice recognition device 1100 and smart gateway 1200 shall use only one AC adapter power unit instead of two. The third advantage is that with such direct mounting, smart gateway device 1200 can always maintain Bluetooth connections with voice recognition device 1100. Finally, the fourth advantage is that system 1000B eliminates unwanted interferences between voice recognition device 1100 and smart gateway 1200 by other Bluetooth devices and/or other 2.4 GHz wireless signals nearby.

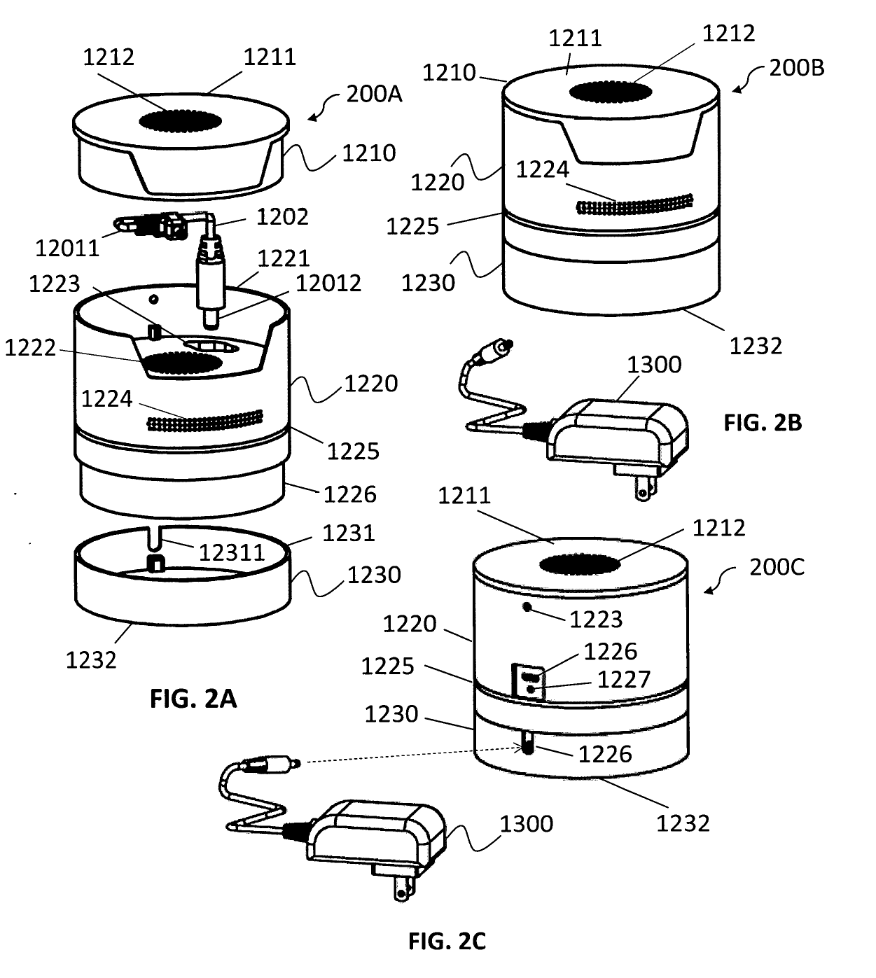

Now referring to FIG. 2A-FIG. 2C illustrating different views of the mechanical design of smart gateway 1200 so that voice recognition device 1100 can be mounted on top of smart gateway 1200 into a single removable unit 1000B in accordance with exemplary embodiments of the present invention.

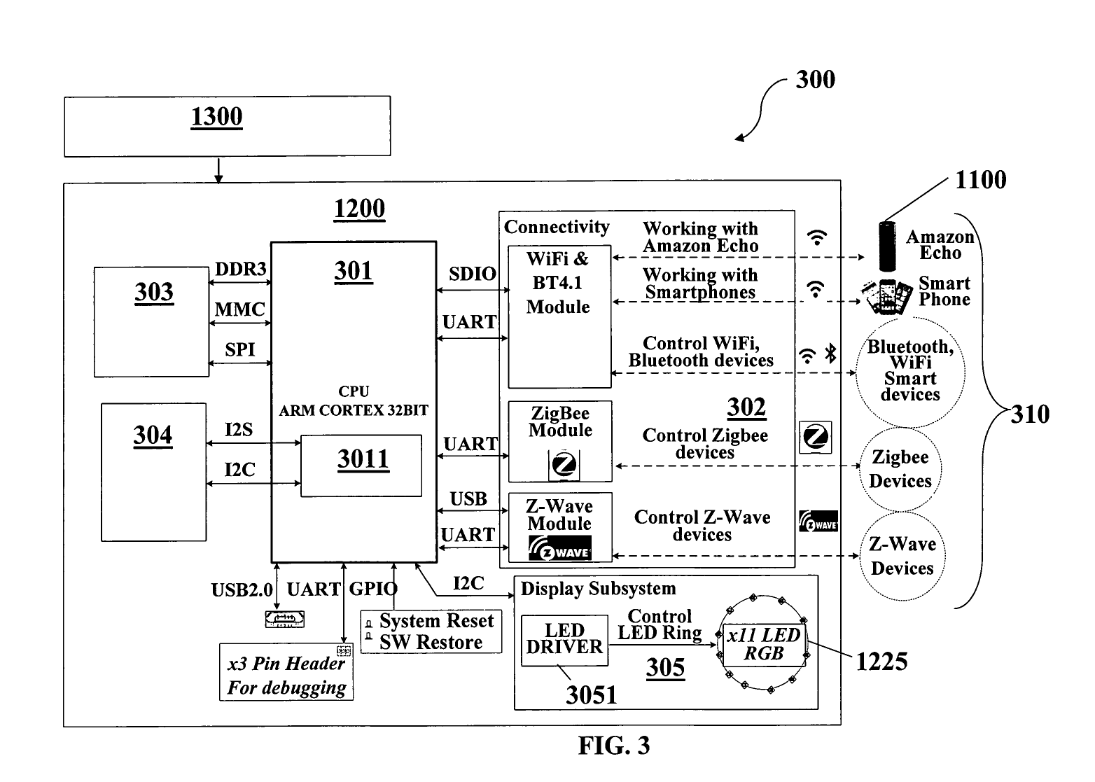

FIG. 2A is a mechanical drawing of different components of smart gateway 1200. In an exemplary embodiment, smart gateway 1200 includes a top cap 1210, a main box 1220, and a bottom cap 1230. Top cap 1210 has a top side 1211. Below top surface of top cap 1211, a section having a slightly smaller radius than top cap 1210 extends vertically downward so that top cap 1210 is engaged in flush with main box 1220 into a cylindrical box. A first circular opening 1212 is located at the center of top cap 1210. Main box 1220 has a top side 1221 and a bottom side 1226. Top side 1221 is a vertical wall projecting upward around the rim of main box 1220. Vertical wall of top side 1221 has a partial cut-away at the front side of main box 1220. On the top surface of main box 1220, a second circular opening 1222 is located at the center so that it is aligned perfectly with first circular opening 1212. A third opening 1223 is located next to second circular opening 1222 so that DC power adaptor cable 1201 can electrically connect voice recognition device 1100 and smart gateway 1200. Front side of main box 1220 has a plurality of holes 1224 arranged in form of a matrix where audio subsystem (discussed later in FIG. 3) of smart gateway 1200 is located. Below plurality of holes 1224 is a light emitting diodes (LED) ring 1225 wrapping around the outer perimeter of main box 1220. LED ring 1225 includes a total of 11 LED with three different colors red, blue, and green (RBG) designed to serially circle around the perimeter of smart gateway 1200 when a voice command being executed. Bottom section 1226 of main box 1220 has a radius slightly smaller than that of main box 1220. Bottom section 1226 is designed so that bottom cap 1230 is engaged with main box 1220 to form a cylindrical box as shown in FIG. 2B and FIG. 2C. Bottom cap 1230 is a circular cap having a top side 1231 and a bottom side 1232. Top side 1231 has a small rounded cut-in adapted to expose a hole which receives wall-mount AC adaptor power unit 1300.

FIG. 2B is a mechanical drawing 200B illustrating one side of smart gateway 1200 when top cap 1210, main box 1220, and bottom cap 1230 are engaged together so that smart gateway 1200 is a cylindrical box. In one preferred embodiment, smart gateway 1200 is designed to be a cylindrical box having a diameter of 3.4 inches so that smart gateway 1200 can receive voice recognition device 1100 such as the Amazon Echo®.

Now FIG. 2C is a mechanical drawing 200C illustrating the opposite side of smart gateway 1200 when top cap 1210, main box 1220, and bottom cap 1230 are engaged together so that smart gateway 1200 is a cylindrical box. On this side of smart gateway 200, a light emitting diode (LED) power indicator 1223 is located near the top of main box 1220. LED power indicator 1223 is turned on when power supply from smart gateway 1200 is connected to voice recognition device 1100 such as Amazon Echo®. Right below LED power indicator 1223 is a square cut-in containing a Universal Serial Bus (USB) 1226, and a reset button 1227. USB connector 1226 is designed to update firmware of smart gateway 1200 by external devices (not shown). In one embodiment, when smart gateway 1200 is used alone without voice recognition unit 1100, USB connector 1226 is connected with external computer which displays the status of software applications executed by mobile devices. Finally, a connector 12261 located on bottom section 1226 is aligned perfectly with cut-in 12311 to receive wall-mount AC adaptor power unit 1300.

Next referring to FIG. 3, a schematic diagram of the internal structure of smart gateway 1200 is illustrated. In one exemplary embodiment, smart gateway 1200 includes a central processor unit (CPU) 301, a connectivity unit 302 adapted to connect various smart devices 310 such as Bluetooth, Wi-Fi, ZigBee, Z-Wave devices to CPU 301, a memory sub-system 303, and an audio subsystem 304. In one preferred embodiment, CPU 301 also includes a status report unit 3011. In an exemplary embodiment, CPU 301 is a 32-bit Texas Instrument ARM CORTEX further including status report unit 3011. In another exemplary embodiment, status report unit 3011 can be a firmware, a software application operating with a hardware unit. Status report unit 3011 receives connectivity status and/or operation status from smart devices 310. In one embodiment, status report unit 3011 sends the status information to audio subsystem 304. Audio subsystem 304 decodes the status and reports in human voice via a speaker located at plurality of holes 1224. Alternatively, in another exemplary embodiment, status report unit 3011 can be paired with the speakers of voice recognition device 1100 via Bluetooth connections. In one embodiment, smart gateway 1200 also includes a display subsystem 305 which has a light emitting diode driver 3501 driving a series of RGB light emitting diodes (LED) 1225 adapted to circle around when smart gateway 1200 is executing a voice command.

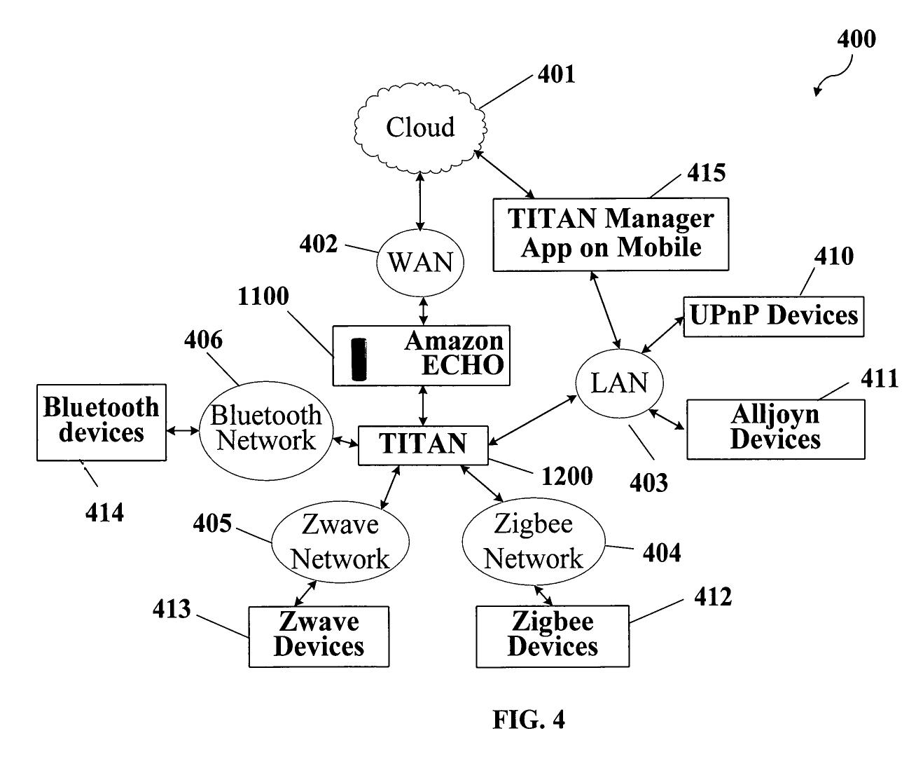

Now referring to FIG. 4, a schematic diagram 400 illustrating the connections between voice recognition device 1100 connected directly on top of smart gateway 1200 also connected to smart devices 310 is shown. Mechanically, when voice recognition device 1100 is mounted directly on top of smart gateway 1200 into a single unit 1000B as shown in FIG. 1B, top cap 1210 is not used. In one exemplary embodiment, voice recognition device 1100 is the Amazon Echo®. Amazon Echo® is a cloud based intelligence that provides voiced controlling personal assistance and user interface for smart devices 310. As such, voice recognition device 1100 is connected to a Amazon cloud server 401 which includes the Alexa service. Smart gateway 1200 is also connected to cloud server 401 via a wide area network (WAN) 402. Smart gateway 1200 is connected to universal plug-and-play (uPnP) Wi-Fi devices 410 and AllJoyn Wi-Fi devices 411 via a Wi-Fi Local Area Network (LAN) 403. In the present invention, smart gateway 1200 is also connected to smart devices 310 which include ZigBee devices 412 via a ZigBee network 404, Z-Wave devices 413 via a Z-Wave network 405. Smart gateway 1200 is also designed to connect to Bluetooth devices 414 via a Bluetooth Network 406. The structures and operations of uPnP devices 410, AllJoyn devices 411, ZigBee devices 412, Z-Wave devices 413, and Bluetooth devices 414 are well-known in the art and therefore are not discussed in details here.

Continuing with FIG. 4, in operation, after connected voice recognition device 1100 directly on top of smart gateway 1200, when a user sends a voice command to voice recognition device 1100, voice recognition device 1100 records the voice command and then sends the voice command to cloud server 401 which includes Alexa Service. Cloud server 401 determines the skill support, translates the voice command into text command and forwards the text command to smart gateway 1200 which contains the identification of each smart device 310. Smart gateway 1200 finally interprets the received text command and then sends the text command to the corresponding smart devices 310 including Wi-Fi uPnP devices 410, AllJoyn devices 411, ZigBee Wi-Fi devices 412, Z-Wave devices 413, and Bluetooth devices 414. In an alternative embodiment, mobile devices 415 are connected between LAN 403 and cloud server 401 to execute software applications that perform voice commands for smart gateway 1200 when smart gateway 1200 is not connected with voice recognition device 1100. In this situation, an external computer (not shown) can be connected to smart gateway 1200 at USB connector 1226 to display the status of the voice commands performed by the software applications. Mechanically, when used alone, top cap 1210 is placed on top of main box 1220.

Still referring to FIG. 4, in a preferred embodiment, users can request adding or deleting any smart devices 310 from cloud server 401. Status report unit 3011 of CPU 301 determines the connectivity and operation status of each smart device 310 and reports the status in the form of a human voice. In one embodiment, the status report can be achieved via Bluetooth connection with the speakers inside voice recognition device 1100 such as the Amazon Echo®. Alternatively, when voice recognition device 1100 is disconnected from smart gateway 1200 to operate alone, the status report can be performed by audio subsystem 304. Either way, status report unit 3011 enables users to know the status of each voice command. For example, a user requests, “Alexa, turn on living room lights”. Note that living room light switches are Wi-Fi uPnP devices 410. After going through the procedure described above and sending the command into cloud server 401, Alexa replies, “Living room lights are on.” This feature of the present invention allows a user to ascertain that the living room lights are successfully turned on.

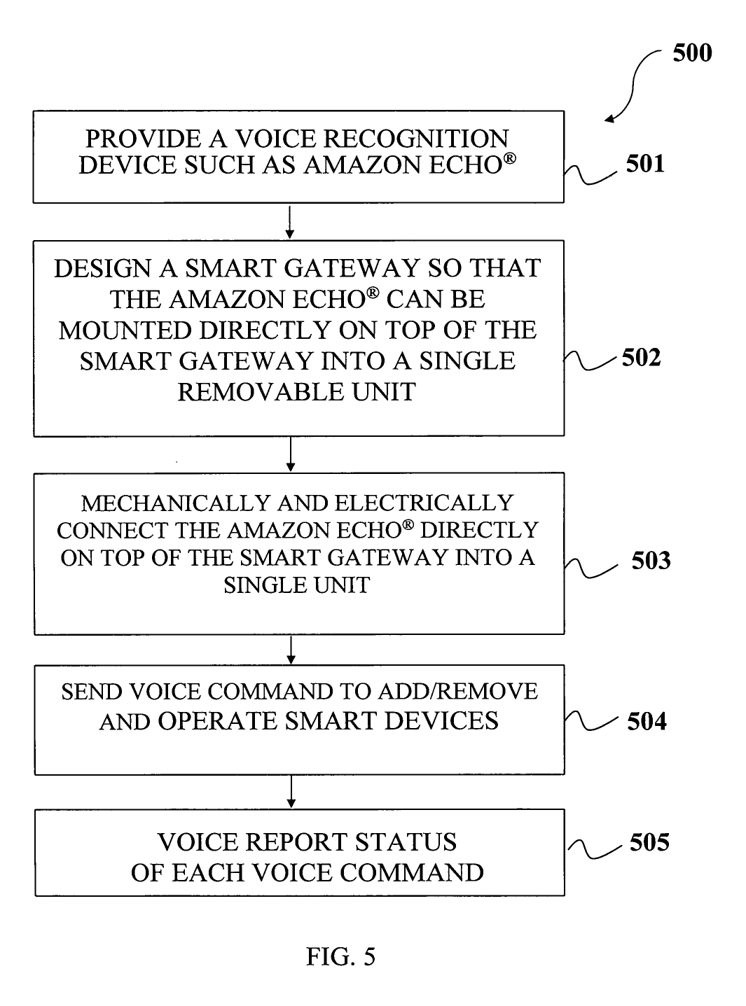

Finally, referring to FIG. 5, a method 500 for controlling smart devices is illustrated.

At step 501, a voice recognition device is provided. The voice recognition device can be the Amazon Echo® having Alexa Cloud service which can be purchased in the market.

At step 502, a smart gateway device with status report unit is provided so that the Amazon Echo® can be mechanically mounted directly on top of the smart gateway into a single removable unit. Step 502 is realized by smart gateway device 1200 as illustrated in FIG. 1 having a central processing unit (CPU) 301 with status report unit 3011. Status report unit 3011 monitors all the connectivity status and operation status of smart devices 310 and provides such status information to audio subsystem 304 within smart gateway 1200 or those of Amazon Echo® via Bluetooth connections.

At step 503, the voice recognition device such as the Amazon Echo® is electrically and mechanically mounted directly on top of the smart gateway into a removable unit so as to reduce unwanted interferences from other Bluetooth devices such as 414 in FIG. 3 and to maintain Bluetooth connections. In practice, step 503 is realized by system 1000B described in FIG. 1B.

Next at step 504, voice commands such as adding/removing and controlling the operations of smart devices are sent by a user. In reality, step 504 is realized by the operation of system 400 described in FIG. 3 above.

Finally at step 505, connectivity status and operation status of each voice command are reported in a human voice. In practice, Step 505 is realized by status report unit 3011. In one exemplary embodiment, status report unit 3011 within CPU 301 is paired with speakers of Amazon Echo® via Bluetooth connections to report the status of each voice command. In another exemplary embodiment, status report unit 3011 sends the status information to audio subsystem 304 when smart gateway 1200 is used alone and disconnected from the Amazon Echo®.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

1. A system for controlling a plurality of smart devices, comprising:
a cloud-based voice recognition device operable to receive, recognize, and transform input human voices of users into electrical signals that control activities of said plurality of smart devices; and
a smart gateway, different from and mechanically mounted directly below said cloud-based voice recognition device into a single removable unit so as to provide power supplies, reduce interferences, and to maintain wireless connections with said voice recognition device, wherein said smart gateway is operable to transform said electrical signals into commands that order each of said plurality of smart devices to perform specific activities, wherein said smart gateway is configured to generate output human voices reporting back to said users the completion and/or the status of said specific activities of each of said plurality of smart devices.

2. The system for controlling a plurality of smart devices of claim 1 wherein said cloud-based voice recognition device receives said input human voices, sends said input human voices to a cloud server for translating said input human voices into electrical signals in form of text commands understood by said plurality of smart devices.

3. The system for a plurality of controlling smart devices of claim 1 wherein said cloud-based voice recognition device is an Amazon Echo® device.

4. The system for controlling a plurality of smart devices of claim 1 wherein said smart gateway is adapted to communicate with said cloud server via a wide area network (WAN).

5. The system for controlling a plurality of smart devices of claim 1 wherein said plurality of smart devices further comprises universal plug-and play (uPnP) devices, AllJoyn devices, Z-Wave devices, ZigBee devices, and Bluetooth devices.

6. The system for controlling a plurality of smart deices of claim 5 wherein said smart gateway is connected to said uPnP devices and said AllJoyn devices via a local area network (LAN).

7. The system for controlling a plurality of smart deices of claim 5 wherein said smart gateway is connected to said ZigBee devices via a ZigBee network, to said Z-Wave devices via a Z-Wave network, and to Bluetooth devices via a Bluetooth network.

8. The system for controlling a plurality of smart devices of claim 1 wherein said smart gateway further comprises a central processing unit (CPU) which comprises a voice status report unit operative to generate said output human voices reporting activities of each of said plurality of smart devices.

9. The system for controlling a plurality of smart devices of claim 8 further comprises an audio subsystem electrically coupled to said voice status report unit so as to generate said output human voices reporting activities of each of said plurality of smart devices.

10. The system for controlling a plurality of smart devices of claim 9 wherein said voice status report unit is capable of paring with either said voice recognition device or said audio subsystem for reporting said activities of each of said smart devices which comprises connectivity status and/or operation status of each of said smart devices in form of said output human voices.

11. The system for controlling a plurality of smart devices of claim 10 wherein said voice status report unit is paired to at least one speakers of said voice recognition device via Bluetooth.

12. The system for controlling a plurality of smart devices of claim 11 wherein said smart gateway is capable of enabling a mobile phone to control said plurality of smart devices.

13. The system for controlling a plurality of smart devices of claim 1 further comprising a power supply unit mechanically mounted directly below said smart gateway for providing power supplies to said smart gateway and said cloud-based voice recognition device.

14. A method for controlling a plurality of smart devices, comprising:
providing a cloud-based voice recognition device;
designing a smart gateway so that said cloud-based voice recognition device is adapted to mount directly on top of said smart gateway into a single removable unit; and
mechanically and electrically connecting said cloud-based voice recognition device directly on top of said smart gateway into said single removable unit, wherein said smart gateway is different from and configured to generate output human voices giving commands to said plurality of smart devices for performing specific activities and reporting said specific activities of each of said plurality of smart devices.

15. The method of claim 14 wherein said smart gateway further comprises a status report unit configured to report connectivity and operation status of each of said plurality of smart devices.

16. The method of claim 15 further comprising:
adding said plurality of smart devices into a database of said smart gateway for controlling said plurality of smart devices;
removing at least one smart devices from said plurality of smart devices; and
reporting the connectivity status of each of said plurality of smart devices every time a new smart device among said plurality of smart devices is either added into or removed from said database using said status report unit.

17. The method of claim 16 wherein said reporting the connectivity status is in form of human voices and wherein said report the connectivity status and/or operation status are either by said cloud-based voice recognition device paired with said smart gateway via a Bluetooth connection or by said smart gateway using an audio subsystem.

18. The method of claim 14 wherein said smart gateway is adapted to communicate with a cloud server via a wide area network (WAN).

19. The method of claim 14 wherein said plurality of smart devices further comprises universal plug-and play (uPnP) devices, AllJoyn devices, Z-Wave devices, ZigBee devices, and Bluetooth devices.

20. The method of claim 14 wherein said smart gateway is connected to said uPnP devices and said AllJoyn devices via a local area network (LAN), and wherein said smart gateway is connected to said ZigBee devices via a ZigBee network, to said Z-Wave devices via a Z-Wave network, and to Bluetooth devices via a Bluetooth network.
